(19) United States
(12) Patent Application Publication
(10) Pub. No.: US 2012/0225602 A1
(43) Pub. Date: Sep. 6, 2012

(54) FUSER MANUFACTURE AND APPARATUS

(75) Inventors: Yu Qi, Oakville (CA); Nan-Xing Hu, Oakville (CA); Carolyn P. Moorlag, Mississauga (CA); Qi Zhang, Misissauga (CA)

(73) Assignee: Xerox Corporation, Norwalk, CT (US)

(21) Appl. No.: 13/040,568

(22) Filed: Mar. 4, 2011

(51) Int. Cl. D04H 13/00; C08K 3/04; C08K 3/34; B29C 35/08; C08L 79/08; C08K 3/22; B82Y 30/00

(52) U.S. Cl. 442/365; 525/182; 524/514; 524/430; 524/445; 442/327; 264/463; 977/742

(57) ABSTRACT

There is described a method for producing a fuser sleeve. The method includes electrospinning polymeric fibers on a conductive surface to form a non-woven fiber layer. A mixture of a fluoropolymer and a solvent is coated on the non-woven fiber layer. The mixture is heated to remove the solvent and then heated to a temperature above a melting temperature of the fluoropolymer thereby having the fluoropolymer penetrate the non-woven fiber layer and form a fuser sleeve. The sleeve is detached from the conductive surface. There is also provided a fuser sleeve comprising a fluoropolymer dispersed in a plurality of non-woven polymer fibers.

### BACKGROUND

1. Field of Use

This disclosure is generally directed to fuser members useful in electrophotographic imaging apparatuses, including digital, image on image, and the like. This disclosure also relates to processes for making and using fuser members.

2. Background

Generally, in a commercial electrophotographic marking or reproduction apparatus (such as copier/duplicators, printers, multifunctional systems or the like), a latent image charge pattern is formed on a uniformly charged photoconductive or dielectric member. Pigmented marking particles (toner) are attracted to the latent image charge pattern to develop this image on the photoconductive or dielectric member. A receiver member, such as paper, is then brought into contact with the dielectric or photoconductive member and an electric field applied to transfer the marking particle developed image to the receiver member from the photoconductive or dielectric member. After transfer, the receiver member bearing the transferred image is transported away from the dielectric member to a fusion station and the image is fixed or fused to the receiver member by heat and/or pressure to form a permanent reproduction thereon. The receiving member passes between a pressure roll and a heated fuser member.

Paper-edge wear and scratch damage at the fuser surface are two major failure modes that limit fuser member life. To extend fuser member life, a number of topcoat materials have been developed, such as fluoropolymer composites containing inorganic fillers. To meet the long life requirement, and therefore achieve significant operating cost reduction, there is a continuous demand for new fuser materials that provide robust, low surface energy topcoat surfaces. Such surfaces help enable oil-less fusing, provide longer life, and provide tunable properties for the final print.

Sleeved topcoats have been widely used, especially for oil-less fusers such as TOS (Teflon-on-Silicone) fusers. For TOS fusers, the sleeved topcoats avoid using the high temperature processes which degrade the cushioning layer under the surface layer.

A fuser member having a sleeved topcoat that provides long life is desirable.

### SUMMARY

According to an embodiment, there is provided a fuser sleeve comprising a fluoropolymer dispersed in a plurality of non-woven polymer fibers.

According to an embodiment, a method for the production of a fuser sleeve is provided. The method includes electrospinning polymeric fibers on a conductive surface to form a non-woven fiber layer. A mixture of a fluoropolymer and a solvent is coated on the non-woven fiber layer. The mixture is heated to remove the solvent and then heated to a temperature above a melting temperature of the fluoropolymer thereby having the fluoropolymer penetrate the non-woven fiber layer and form a fuser sleeve. The sleeve is detached from the conductive surface.

According to an embodiment, there is provided a fuser member. The fuser member comprises a substrate and a silicone layer disposed on the substrate. An outer sleeve is disposed on the silicone layer comprising a nonwoven polymer fiber layer having a fluoropolymer disposed thereon.

### BRIEF DESCRIPTION OF THE DRAWINGS

The accompanying drawings, which are incorporated in and constitute a part of this specification, illustrate several embodiments of the present teachings.

FIG. 1 is a schematic of an embodiment of a fuser roller.

FIG. 2 is an apparatus used for manufacturing a fuser sleeve.

It should be noted that some details of the drawings have been simplified and are drawn to facilitate understanding of the embodiments rather than to maintain strict structural accuracy, detail, and scale.

### DESCRIPTION OF THE EMBODIMENTS

Reference will now be made in detail to embodiments of the present teachings, examples of which are illustrated in the accompanying drawings. Wherever possible, the same reference numbers will be used throughout the drawings to refer to the same or like parts.

In the following description, reference is made to the accompanying drawings that form a part thereof, and in which is shown by way of illustration specific exemplary embodiments in which the present teachings may be practiced. These embodiments are described in sufficient detail to enable those skilled in the art to practice the present teachings and it is to be understood that other embodiments may be utilized and that changes may be made without departing from the scope of the present teachings. The following description is, therefore, merely exemplary.

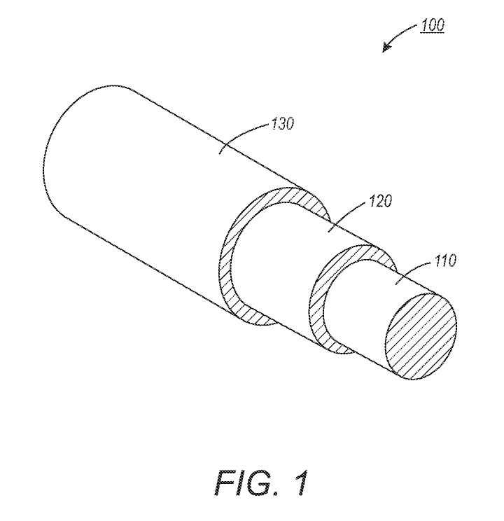

FIG. 1 is a schematic view of an embodiment of a fuser member 100, demonstrating various possible layers. As shown in FIG. 1, a substrate 110 has an intermediate or cushioning layer 120 thereon. Intermediate or cushioning layer 120 can be, for example, a silicone rubber. On intermediate layer 120 is an outer layer 130 that is a sleeve.

Fuser rolls used in electrophotographic marking systems generally comprise a substrate 110 shown herein as a core cylinder having one or more intermediate layers 120 such as silicone. The intermediate layer 120 can include silicone rubbers such as room temperature vulcanization (RTV) silicone rubbers, high temperature vulcanization (HTV) silicone rubbers, low temperature vulcanization (LTV) silicone rubbers and liquid silicone rubbers (LSR). These rubbers are known and readily available commercially, such as SILASTIC® 735 black RTV and SILASTIC® 732 RTV, both from Dow Corning; and 106 RTV Silicone Rubber and 90 RTV Silicone Rubber, both from General Electric. Other suitable silicone materials include siloxanes (such as polydimethylsiloxanes); fluorosilicones such as Silicone Rubber 552, available from Sampson Coatings, Richmond, Va.; liquid silicone rubbers such as vinyl crosslinked heat curable rubbers or silanol room temperature crosslinked materials; and the like. Another specific example is Dow Corning Sylgard 182.

Optionally, any known and available suitable adhesive or primer layer may be positioned between the intermediate layer 120, the electrospun fluoropolymer sleeve 130 and the substrate 110. Examples of suitable adhesives include silanes such as amino silanes (such as, for example, HV Primer 10 from Dow Corning), titanates, zirconates, aluminates, and the like, and mixtures thereof. In an embodiment, an adhesive in from about 0.001 percent to about 10 percent solution can be applied to the substrate. The adhesive layer can be coated on the substrate, or on the outer layer, to a thickness of from about 2 nanometers to about 2,000 nanometers, or from about 2 nanometers to about 500 nanometers for a silane adhesive. The adhesive can be coated by any suitable known technique, including spray coating or wiping.

In some embodiments, the intermediate layer 120 includes silicone. Alternatively, the intermediate layer 120 may comprise components other than silicone. In embodiments, the intermediate layer contains at least about 30 volume percent, or at least about 50 volume percent silicone, or at least 70 volume percent silicone, depending on thermal conductivity requirements.

Examples of suitable substrate 110 materials include, in the case of a roller substrate, metals such as aluminum, stainless steel, steel, nickel and the like. In embodiments, the substrate material can include polymers such as polyimides, polyamideimides, polyetherimides, polyether ether ketones and polyphenylene sulfides.

A method of providing outer layer 130 on the intermediate layer includes positioning an outer sleeve 130 around a substrate having the silicone intermediate layer thereon. The fuser member 100 is heated to a temperature to cause the sleeve to shrink and thereby securely bond to the intermediate layer. In embodiments, an adhesive layer, sometimes referred to as a primer layer, is included between the intermediate layer and the sleeve.

In the methods of manufacturing fuser members described above, the inner surface of the sleeve can be etched to increase adhesion. In addition, the outer surface of the substrate can be roughened to increase adhesion with the silicone and/or primer layers.

Described herein is a fabrication process to make a fuser sleeve containing non-woven polymer fiber fabrics. More specifically, the non-woven polymer fabric is made by electrospinning of polymer on a conductive metal drum collector, followed by coating a fluoropolymer dispersed in a solvent. After removing the solvent with heat, the fluoropolmer is heated above its melting temperature to form a sleeve. The removal of the solvent and the melting of the fluoropolymer can be accomplished in one procedure. The resulting coated sleeve is detached from the drum and applied as the fuser topcoat to the substrate as described previously. The fuser sleeve of non-woven polymer fabric having a fluoropolymer disposed throughout provides high mechanical strength for fuser life extension and desired low surface energy property for toner release performance.

Nonwoven fabrics are broadly defined as sheet or web structures bonded together by entangling fiber or filaments (and by perforating films) mechanically, thermally or chemically. They are flat, porous sheets that are made directly from separate fibers or from molten plastic or plastic film. They are not made by weaving or knitting and do not require converting the fibers to yarn. Compared to the conventional non-woven fabrics, the fabrics described herein have the advantages of high surface area for strong interaction between the fabrics and the filler polymer, high loading in the composite coating (>50%), uniform, well-controlled morphology and ultra-low surface energy. Various functionality can be applied to the woven nanofibers which allows one to tune the properties of the resultant fuser sleeve.

Electrospinning provides a simple and versatile method for generating ultrathin fibers from a rich variety of materials that include polymers, composites and ceramics. To date, numerous polymers with a range of functionalities have been electospun as nanofibers. In electrospinning, a solid fiber is generated as the electrified jet (composed of a highly viscous polymer solution with a viscosity range of from about 1 to about 400 centipoises, or from about 5 to about 300 centipoises, or from about 10 to about 250 centipoises) is continuously stretched due to the electrostatic repulsions between the surface charges and the evaporation of solvent. Suitable solvents include dimethylformamide, dimethylacetamide, 1-Methyl-2-pyrrolidone, tetrahydrofuran, a ketone such as acetone, methylethylketone, dichloromethane, an alcohol such as ethanol, isopropyl alcohol, water and mixtures thereof. The weight percent of the polymer in the solution ranges from about 1 percent to about 60 percent, or from about 5 percent to about 55 percent to from about 10 percent to about 50 percent.

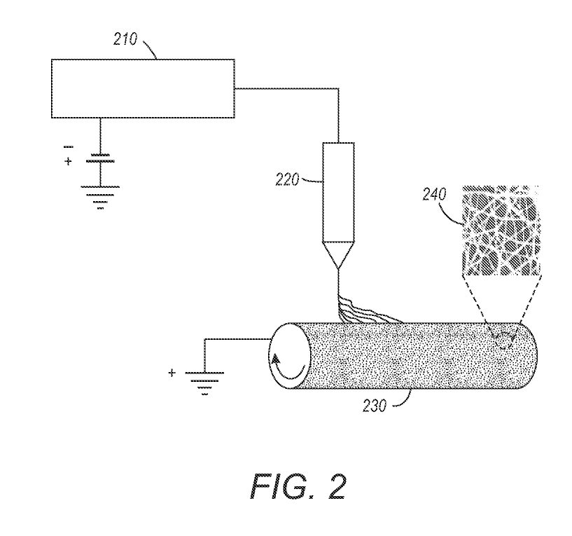

An apparatus for electrospinning and producing a fuser sleeve 130 (FIG. 1) is shown schematically in FIG. 2. The apparatus includes three major components: a high-voltage power supply 210, a spinneret 220 (also referred to as an electrospinner nozzle), and a rotating collector 230 shown as a conductive metal drum in FIG. 2. The voltage ranges from 1 to 40 kv, temperature is ambient, e.g. 25° C. The rotational speed is at least 10 rpm. Electrospinning in general, methods for the preparation of ultrathin fibers by electrospinning are disclosed in a review article by Andreas Greiner and Joachim H. Wendorff in Angew. Chem. Int. Ed. 2007, 46, 5670-5703. Electrospun nanofibers exhibit a range of unique features such as extremely long length, ultrathin diameter and the capability of being aligned on the molecular level. In embodiments the entangled electrospun fibers have an aspect ratio of from about 10 to about 1,000,000, or from about 100 to 100,000 or from about 1000 to about 10,000. In embodiments the plurality of entangled electrospun fibers have a diameter in the range of about 1 nm to about 100 microns, or from about 5 nm to about 50 micron, or from about 10 nm to about 10 microns. Shown in FIG. 2 is an inset 240 of an expanded view of the non-woven fabric of polymer fibers.

After a non-woven polymer nanofabric sleeve has been produced, a fluoropolymer can be deposited on the non-woven nanofabrics. The process can be either powder coating of a fluoropolymer powder, spray coating of a fluoropolymer in dispersion, or flow coating of a fluoropolymer in a solution. After coating the fluoropolymer, the sleeve is heat-treated to a temperature to remove the solvent or the dispersion media, then to a temperature to cure the fluoropolymer at temperatures ranging from 150 to 350° C. After cooling, the coating is detached from the drum and the resulting sleeve is used as the fuser topcoat. The nonwoven nanofabric comprises from about 30 weight percent to about 99 weight percent of the fuser sleeve. In embodiments, the nonwoven nanofabric comprises from about 40 weight percent to about 90 weight percent, or from about 50 weight percent to about 90 weight percent of the fuser sleeve

The resultant sleeve can be tuned to have specific properties based on the functionality of polymers and morphology of fibers. Because of the high surface-to-volume ratio, use of nanofibers in a composite can significantly increase the interaction between the fibers and the matrix material, leading to better reinforcement than conventional fibers. Similar to micro-sized fibers used as reinforcement in certain composite materials, electrospun nanofiber-reinforced polymer nanocomposites should provide superior mechanical properties such as high modulus and strength. As the nanofibers possess unique features such as, smaller diameter, long length and high surface area (e.g. 10 to 400 m²/g), they can have more effective interaction with the polymer matrix, and therefore provide better mechanical properties than micro fibers of the same materials.

Electrospun fibers can be made of an organic, an inorganic material, or a combination thereof. In embodiments, the electrospun layer can include polymers, ceramics, glass, metal-containing materials, such as sol-gel type metal oxides, semiconductors such as silicon, or other suitable materials that can be formed by electrospinning process. Various materials can be used as electrospun materials to form the electrospun fibers including, but not limited to, polymers, ceramics, composites, and/or the combinations thereof. Suitable synthetic and/or natural materials can be used.

Exemplary materials used for the electrospun fibers can include polyamide, such as aliphatic and/or aromatic polyamide, polyester, polyimide, polycarbonate, polyurethane, polyether, polyoxadazole, polybenzimidazole, polyacrylonitrile, polycaprolactone, polyethylene, polypropylenes, acrylonitrile butadiene styrene (ABS), polybutadiene, polystyrene, polymethyl-methacrylate (PMMA), polyhedral oligomeric silsesquioxane (POSS), poly(vinyl alcohol), poly(ethylene oxide), polylactide, poly(caprolactone), poly(ether imide), poly(ether urethane), poly(arylene ether), poly(arylene ether ketone), poly(ester urethane), poly(p-phenylene terephthalate), cellulose acetate, poly(vinyl acetate), poly(acrylic acid), polyacrylamide, polyvinylpyrrolidone, hydroxypropylcellulose, poly(vinyl butyral), poly(alkly acrylate), poly(alkyl methacrylate), polyhydroxybutyrate, fluoropolymer, poly(vinylidene fluoride), poly(vinylidene fluoride-co-hexafluoropropylene), fluorinated ethylene-propylene copolymer, poly(tetrafluoroethylene-co-perfluoropropyl vinyl ether), poly((perfluoroalkyl)ethyl methacrylate), cellulose, chitosan, gelatin, protein, and mixtures thereof. In embodiments, the electrospun fibers can be formed of a tough polymer such as Nylon, polyimide, and/or other tough polymers.

In embodiments, the electrospun fibers can have a diameter ranging from about 5 nm to about 50 μm, or ranging from about 50 nm to about 20 μm, or ranging from about 100 nm to about 1 μm. In embodiments, the electrospun fibers can have an aspect ratio about 100 or higher, e.g., ranging from about 100 to about 1,000, or ranging from about 100 to about 10,000, or ranging from about 100 to about 100,000. In embodiments, the non-woven fabrics can be non-woven nano-fabrics formed by electrospun nanofibers having at least one dimension, e.g., a width or diameter, of less than about 1000 nm, for example, ranging from about 5 nm to about 500 nm, or from 10 nm to about 100 nm.

Suitable fluoropolymers can include fluoroplastics, fluoroelastomers, and/or fluororesins. For example, the fluoropolymer can include one or more repeating units each corresponding to a monomer. The monomer can include, e.g., tetrafluoroethylene (TFE), hexafluoropropylene (HFP), perfluoropropyl vinyl ether (PPVE), perfluoroethyl vinyl ether (PEVE), perfluoromethyl vinyl ether (PMVE), chlorotrifluoroethylene (CTFE), vinyl fluoride (VF), and vinylidene fluoride (VDF), and a combination thereof. In an additional example, the fluoropolymers can be selected from the group consisting of polytetrafluoroethylene (PTFE), perfluoroalkoxy polymer resin (PFA), fluorinated ethylenepropylene copolymer (FEP), copolymers of tetrafluoroethylene (TFE) and hexafluoropropylene (HFP), copolymers of hexafluoropropylene (HFP) and vinylidene fluoride (VDF), terpolymers of tetrafluoroethylene (TFE), vinylidene fluoride (VDF), and hexafluoropropylene (HFP), and tetrapolymers of tetrafluoroethylene (TFE), vinylidene fluoride (VF2), hexafluoropropylene (HFP) and a cure site monomer combinations thereof.

Examples of conductive particles or fillers that can be included in the fluoropolymer sleeve 130 and the fluoropolymer and solvent mixture include carbon nanotubes (CNT); carbon blacks such as carbon black, graphite, acetylene black, graphite, grapheme, fluorinated carbon black, and the like; metal, metal oxides and doped metal oxides, such as tin oxide, antimony dioxide, antimony-doped tin oxide, titanium dioxide, indium oxide, zinc oxide, indium oxide, indium-doped tin trioxide, silicon carbide, metal carbide and the like; silica, clay and mixtures thereof. The conductive particles may be present in an amount of from about 0.1 volume percent to about 30 volume percent, or from about 0.5 volume percent to about 20 volume percent, or from about 1 volume percent to about 10 volume percent of total solids to the fluoropolymer in the sleeve. The same conductive particles or filler can be included in the intermediate layer. The intermediate layer typically has from about 15 volume percent to about 50 volume percent of conductive particles or fillers, or from about 20 volume percent to about 45 volume percent of conductive particles or fillers or from about 25 volume percent to about 35 volume percent of conductive particles or fillers.

The resultant sleeve can be tuned to have specific properties based on the functionality of polymers and morphology of fibers. The fuser sleeve has a tensile strength at least about 3,000 psi, ranging from about 3,000 psi to about 500,000 psi, or from about 5,000 psi to about 9,000 psi, or from about 6,000 psi to about 8,000 psi. The fuser sleeve has an elongation percent of at least about 30%, ranging from about 100% to about 600%, or from about 100% to about 500%, or from about 200% to about 400%; and a toughness at least about 5,000 in.-lbs./in.³, ranging from about 5,000 in.-lbs./in.³ to about 500,000 in.-lbs./in.³, or from about 6,000 in.-lbs./in.³ to about 9,000 in.-lbs./in.³, or from about 7,000 in.-lbs./in.³ to about 8,000 in.-lbs./in.³ The Young's Modulus of the electrospun fluoropolymer sleeve 130 is from about 50 kpsi to about 100 kpsi, or from about 70 kpsi to about 95 kpsi, or from about 85 kpsi to about 95 kpsi. Thel modulus of the electrospun sleeve is at least about 1,000 psi, e.g., ranging from about 1,000 psi to about 8,000 psi, or ranging from about 2,000 psi to about 7,000 psi, or ranging from about 3,000 psi to about 6,000 psi. This fuser member 100 described herein exhibits as surface conductivity of less than about 10⁹ Ω/square. However, there are applications where non-electrically conductive sleeves are used and the surface conductive is greater than about 10¹⁴ Ω/square. The surface energy of the sleeve described herein is less than or equal to 25 mN/m, ranging from about 1 mN/m to about 20 mN/m, or from about 5 mN/m to about 15 mN/m, or from about 8 mN/m to about 12 mN/m. The fuser sleeve described herein has a thickness of from about 5 μm to about 250 μm, or from about 10 μm to about 200 μm, or from about 20 μm to about 150 μm.

Specific embodiments will now be described in detail. These examples are intended to be illustrative, and not limited to the materials, conditions, or process parameters set forth in these embodiments. All parts are percentages by solid weight unless otherwise indicated.

### Examples

Fabrication of a Fuser Sleeve with Electrospun Non-Woven Polyimide Fabrics

A fuser sleeve is made by depositing an electrospun non-woven polyimide fabric on a metal drum, followed by coating a PFA aqueous dispersion thereon. After heating at a temperature, e.g. 150° C. to 350° C., then cooling to room temperature, e.g. 25° C., the sleeve is detached from the drum. The formation of the electrospun non-woven polyimide fabric is similar to that described in a journal article, see Polymer Journal (2010) 42, 514-518, which is hereby incorporated by reference in its entirety.

Polyimide fibers about 50-300 nm in diameter are prepared by electrospinning a 6FDA-6FAP polyimide precusor (see structure 1 for the chemical structure) solution in dimethyl formamide on a metal drum. During the electrospinning process, the distance between the spinneret and the grounded plate is from about 25 cm to about 5 cm; the polyimide concentration is from about 9 weight percent to about 20 weight percent; and the voltage between the syringe and the collector was from about 15 kv to about 30 kv.

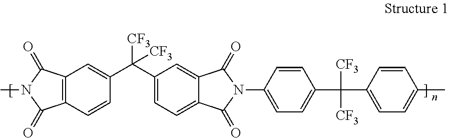

An aqueous dispersion of PFA is then spray-coated onto the fabric layer of the metal drum, followed by a heating process to the PFA melting temperature (e.g. >310° C.) to fill PFA into the fabrics and thus to form an exemplary sleeve.

Other embodiments of the present teachings will be apparent to those skilled in the art from consideration of the specification and practice of the present teachings disclosed herein. It is intended that the specification and examples be considered as exemplary only, with a true scope and spirit of the present teachings being indicated by the following claims.

1. A fuser sleeve consisting of a fluoropolymer dispersed in a plurality of non-woven polymer fibers wherein each of the plurality of non-woven polymer fibers has a diameter of about 5 nm to about 50 μm.

2. The fuser sleeve of claim 1, wherein the fluoropolymer is selected from the group consisting of polytetrafluoroethylene (PTFE); perfluoroalkoxy polymer resin (PFA); copolymers of tetrafluoroethylene (TFE) and hexafluoropropylene (HFP); copolymers of hexafluoropropylene (HFP) and vinylidene fluoride (VDF); terpolymers of tetrafluoroethylene (TFE), vinylidene fluoride (VDF), and hexafluoropropylene (HFP); and tetrapolymers of tetrafluoroethylene (TFE), vinylidene fluoride (VF2), hexafluoropropylene (HFP) and a cure site monomer.

3. The fuser sleeve of claim 1, wherein the polymer fibers comprise a material selected from the group consisting of a polyamide, polyester, polyimide, polycarbonate, polyurethane, polyether, polyoxadazole, polybenzimidazole, polyacrylonitrile, polycaprolactone, polyethylene, polypropylenes, acrylonitrile butadiene styrene (ABS), polybutadiene, polystyrene, polymethyl-methacrylate (PMMA), polyhedral oligomeric silsesquioxane (POSS), poly(vinyl alcohol), poly(ethylene oxide), polylactide, poly(caprolactone), poly(ether imide), poly(ether urethane), poly(arylene ether), poly(arylene ether ketone), poly(ester urethane), poly(p-phenylene terephthalate), cellulose acetate, poly(vinyl acetate), poly(acrylic acid), polyacrylamide, polyvinylpyrrolidone, hydroxypropylcellulose, poly(vinyl butyral), poly(alkly acrylate), poly(alkyl methacrylate), polyhydroxybutyrate, fluoropolymer, poly(vinylidene fluoride), poly(vinylidene fluoride-co-hexafluoropropylene), fluorinated ethylene-propylene copolymer, poly(tetrafluoroethylene-co-perfluoropropyl vinyl ether), poly((perfluoroalkyl)ethyl methacrylate), cellulose, chitosan, gelatin, protein, and mixtures thereof.

4. The fuser sleeve of claim 1, further comprising fillers.

5. The fuser sleeve of claim 4 wherein the fillers are selected from the group consisting of carbon nanotubes (CNT), carbon blacks, metal, metal oxides, doped metal oxides, silica, clay and mixtures thereof.

6. The fuser sleeve of claim 1, wherein the plurality of non-woven polymer fibers are present in an amount ranging from about 30 weight percent to about 99 weight percent of the fuser sleeve.

7. The fuser sleeve of claim 1, wherein each of the plurality of non-woven polymer fibers has an aspect ratio of about 100 to about 100,000.

8. (canceled)

9. The fuser sleeve of claim 1, comprising a thickness of from about 5 μm to about 250 μm.

10. The fuser sleeve of claim 1, comprising a tensile strength from about 3,000 psi to about 500,000 psi.

11. A method of making a fuser sleeve, comprising:
electrospinning polymeric fibers on a conductive surface to form a non-woven fiber layer;
coating a mixture of a fluoropolymer and a solvent on the non-woven fiber layer;
heating the mixture to remove the solvent;
heating the mixture to a temperature above a melting temperature of the fluoropolymer thereby having the fluoropolymer penetrate the non-woven fiber layer; and
detaching the sleeve from the conductive surface.

12. The method of claim 11, wherein the fluoropolymer is selected from the group consisting of polytetrafluoroethylene (PTFE); perfluoroalkoxy polymer resin (PFA); copolymers of tetrafluoroethylene (TFE) and hexafluoropropylene (HFP); copolymers of hexafluoropropylene (HFP) and vinylidene fluoride (VDF); terpolymers of tetrafluoroethylene (TFE), vinylidene fluoride (VDF), and hexafluoropropylene (HFP); and tetrapolymers of tetrafluoroethylene (TFE), vinylidene fluoride (VF2), hexafluoropropylene (HFP) and a cure site monomer.

13. The method of claim 11, wherein the polymeric fibers comprise a material selected from the group consisting of a polyamide, polyester, polyimide, polycarbonate, polyurethane, polyether, polyoxadazole, polybenzimidazole, polyacrylonitrile, polycaprolactone, polyethylene, polypropylenes, acrylonitrile butadiene styrene (ABS), polybutadiene, polystyrene, polymethyl-methacrylate (PMMA), polyhedral oligomeric silsesquioxane (POSS), poly(vinyl alcohol), poly(ethylene oxide), polylactide, poly(caprolactone), poly(ether imide), poly(ether urethane), poly(arylene ether), poly(arylene ether ketone), poly(ester urethane), poly(p-phenylene terephthalate), cellulose acetate, poly(vinyl acetate), poly(acrylic acid), polyacrylamide, polyvinylpyrrolidone, hydroxypropylcellulose, poly(vinyl butyral), poly(alkly acrylate), poly(alkyl methacrylate), polyhydroxybutyrate, fluoropolymer, poly(vinylidene fluoride), poly(vinylidene fluoride-co-hexafluoropropylene), fluorinated ethylene-propylene copolymer, poly(tetrafluoroethylene-co-perfluoropropyl vinyl ether), poly((perfluoroalkyl)ethyl methacrylate), cellulose, chitosan, gelatin, protein, and mixtures thereof.

14. The method of claim 11, wherein the mixture further comprises fillers.

15. The method of claim 14, wherein the fillers are selected from the group consisting of carbon nanotubes (CNT), carbon blacks, metal, metal oxides, doped metal oxides, silica, clay and mixtures thereof.

16. A fuser member comprising:
a substrate;
a silicone layer disposed on the substrate; and
an outer sleeve disposed on the silicone layer consisting of a nonwoven polymer fiber layer having a fluoropolymer disposed thereon wherein each of the plurality of non-woven polymer fibers has a diameter of about 5 nm to about 50 μm.

17. The fuser member of claim 16, wherein the fluoropolymer is selected from the group consisting of polytetrafluoroethylene (PTFE); perfluoroalkoxy polymer resin (PFA); copolymers of tetrafluoroethylene (TFE) and hexafluoropropylene (HFP); copolymers of hexafluoropropylene (HFP) and vinylidene fluoride (VDF); terpolymers of tetrafluoroethylene (TFE), vinylidene fluoride (VDF), and hexafluoropropylene (HFP); and tetrapolymers of tetrafluoroethylene (TFE), vinylidene fluoride (VF2), hexafluoropropylene (HFP) and a cure site monomer.

18. The fuser member of claim 16, wherein the polymer fibers comprise a material selected from the group consisting of a polyamide, polyester, polyimide, polycarbonate, polyurethane, polyether, polyoxadazole, polybenzimidazole, polyacrylonitrile, polycaprolactone, polyethylene, polypropylenes, acrylonitrile butadiene styrene (ABS), polybutadiene, polystyrene, polymethyl-methacrylate (PMMA), polyhedral oligomeric silsesquioxane (POSS), poly(vinyl alcohol), poly(ethylene oxide), polylactide, poly(caprolactone), poly(ether imide), poly(ether urethane), poly(arylene ether), poly(arylene ether ketone), poly(ester urethane), poly(p-phenylene terephthalate), cellulose acetate, poly(vinyl acetate), poly(acrylic acid), polyacrylamide, polyvinylpyrrolidone, hydroxypropylcellulose, poly(vinyl butyral), poly(alkly acrylate), poly(alkyl methacrylate), polyhydroxybutyrate, fluoropolymer, poly(vinylidene fluoride), poly(vinylidene fluoride-co-hexafluoropropylene), fluorinated ethylene-propylene copolymer, poly(tetrafluoroethylene-co-perfluoropropyl vinyl ether), poly((perfluoroalkyl)ethyl methacrylate), cellulose, chitosan, gelatin, protein, and mixtures thereof.

19. The fuser member of claim 16, wherein an outer surface of the outer sleeve comprises a surface energy of less than or equal to 25 mN/m.

20. The fuser member of claim 16 wherein the outer sleeve further comprises fillers.
